(19) United States
(12) Patent Application Publication
(10) Pub. No.: US 2025/0190197 A1
(43) Pub. Date: Jun. 12, 2025

(54) SYSTEM AND METHOD OF ENABLING INTERACTIVE LEARNING FOR CONNECTED VEHICLES

(71) Applicant: GM Global Technology Operations LLC, Detroit, MI (US)

(72) Inventors: Donald K. Grimm, Utica, MI (US); Fan Bai, Ann Arbor, MI (US); Markus Jochim, Troy, MI (US); Lisa Ann Fung, Toronto (CA); William Chanho Song, Thornhill (CA); Christopher Scott Beck, Grosse Pointe, MI (US); Ahmad El Baba, Windsor (CA); Lakshmi V. Thanayankizil, Troy, MI (US)

(21) Appl. No.: 18/530,643

(22) Filed: Dec. 6, 2023

(51) Int. Cl. G06F 8/65; G07C 5/00

(52) U.S. Cl. CPC G06F 8/65; G07C 5/008

(57) ABSTRACT

A method and system of enabling interactive learning for connected vehicles. The system includes a vehicle data hub (VDH) component, a system learning and update (SLU) component, and an application delivery network (ADN). The VDH component enables cloud-coordinated data collection by the connected vehicles. The VDH component includes a vehicle based portion having a smart buffer in communications with a vehicle communications system and a VDH cloud based service portion. The SLU component is a cloud based service configured to manage data campaigns and specific triggers for efficient collection of data, processing the data, and deploy updated and/or new applications based on the processed data to connected vehicles. The ADN component is disposed on the vehicle and prioritize data campaign requests with respect to other active vehicle services.

### INTRODUCTION

The present disclosure relates to connected vehicles; and more particularly to a system and method of enabling interactive learning for connected vehicles.

A connected vehicle has the capability to communicate with the internet, road infrastructure, or even other vehicles or pedestrians through a wireless communications network. Connected vehicles are configured to communicate with other connected vehicles using vehicle-to-vehicle (V2V) communication over the public/federally-owned dedicated short-range communication spectrum (DSRC), through cellular-based to vehicle communications (C-V2X) technology, and with vehicle-to-infrastructure (V2I) communication through Internet of Things (IoT) protocols. Modern connected vehicles employ driver assistance technologies such as Advanced Driver-Assistance Systems (ADAS) to enhance the driver experience and increased vehicle safety and/or Automated Driving Systems (ADS) to reduce or eliminate the need for a human driver. Such ADAS and ADS technologies may encounter unique data collection scenarios that may be required for routine software updates of the systems to ensure optimal performance.

Currently, such unique data collection scenarios may include disparate data collection tasks that require individual data engineering team members to instantiate and deploy. The collected data are stored on servers that require individual data analysts to query and diagnose in order to upgrade or develop a software application for optimal vehicle performance and/or operator experience. While the current method of deploying disparate data collection tasks and diagnosing the collected data may be adequate, there is a continued need for a more efficient method and/or system for collecting and processing data for updating and developing new software applications for connected vehicles.

### SUMMARY

According to several aspects, a system for enabling interactive learning for connected vehicles is provided. The system includes a system learning and update (SLU) component having a SLU module configured to generate data campaign requests including instructions to collect data by a connected vehicle, send the instructions to the connected vehicle to collect the data, receive collected data from the connected vehicle, process the collected data to generate a software application (APP), and send the APP to the connected vehicle; a vehicle data hub (VDH) component having a VDH module configured to assign a priority to the collected data, send the collected data to the SLU module based on the assigned priority from the connected vehicle, and select a wireless communications network to send the collected data based on cost economics; and an application delivery network (ADN) component having an ADN module configured to prioritize the data campaign requests with respect to other active vehicle services.

In an additional aspect of the present disclosure, the instructions include a data requirement including at least one of a data aspect, a spatial aspect, a temporal aspect, and a policy aspect. The instructions may further include detecting a predetermined triggering event before the connected vehicle initiates collecting the data. The triggering event may be the connected vehicle entering a predetermined geospatial area.

In another aspect of the present disclosure, the VDH component includes a smart buffer disposed on the connected vehicle. The smart buffer is configured to prioritize the collected data based on the data requirement and a need of the connected vehicle.

In another aspect of the present disclosure, the SLU module is further configured to generate updated instructions and send the updated instructions to the connected vehicle in real-time.

In another aspect of the present disclosure, the SLU module may be further configured to process the collected data to generate an updated software application (APP) by feeding the collected data to a machine learning architecture.

In another aspect of the present disclosure, the SLU component is implemented on-demand by a cloud computing service. The VDH component comprises a cloud-based VDH portion configured to monitor the collected data including at least one of monitoring, logging, secure storing, and parsing of the collected data.

In another aspect of the present disclosure, the ADN module is configured to interact with a vehicle communications system and a network management system disposed on the connected vehicle for sending the collected data and receiving the APP.

According to several aspects, a method of enabling interactive learning for connected vehicles is provided. The method includes generating instructions, by a system learning and update (SLU) module, for a connected vehicle to collect data; selecting a first wireless communications network, by an application delivery network (ADN) module, to transmit the instructions to a connected vehicle; collecting data, by the connected vehicle, in accordance with the instructions; assigning a priority, by a vehicle data hub (VDH) module, to the collected data before transmitting the collected data to the SLU module; processing the collected data, by the SLU module, to generate a software application (APP) for a vehicle system on the connected vehicle; selecting a second wireless communications network, by the ADN module, to transmit the APP to the connected vehicle; and executing the APP, by a vehicle controller, to physically control the vehicle system.

In an additional aspect of the present disclosure, the instructions include detecting a trigger event before initiating the collecting of data. The trigger event includes at least two event selected from the group consisting of an activation of a predetermined feature of the vehicle, a predetermined observation by the vehicle, and a predetermined action by an operator of the vehicle. The predetermined feature of the vehicle includes an autonomous emergency braking, a detected object, and, and an action of an operator of the vehicle. The instructions may also include a data requirement comprising at least one of a data aspect, a spatial aspect, a temporal aspect, and a policy aspect.

According to several aspects, a system for enabling interactive learning framework for connected vehicles is provided. The system includes a Vehicle Data Hub (VDH) component comprising a smart buffer disposed onboard a connected vehicle and a VDH service portion on a cloud; a System Learning and Update (SLU) component disposed on the cloud, and an Application Delivery Network (ADN) component disposed onboard the connected vehicle. The SLU component is configured to generate a data campaign request and communicate the data campaign request to the connected vehicle, wherein the data campaign includes instructions for collecting data by the connected vehicle. The VDH component is configured to assign a priority to data collected by the connected vehicle. The ADN component is configured to prioritize multiple data campaign requests with respect to other active vehicle services.

In an additional aspect of the present disclosure, the VDH component is further configured to select a wireless communications network for sending the collected data to the SLU component based on cost economics.

In another aspect of the present disclosure, the VDH component includes a smart buffer configured to prioritize the collected data based on data requirement and a need of the connected vehicle.

In another aspect of the present disclosure, the SLU component is further configured to generate updated instructions for collecting data by the connected vehicle and send the updated instructions to the connected vehicle in real-time.

In another aspect of the present disclosure, the SLU module is further configured to process the collected data to generate an updated software application (APP) by feeding the collected data to a machine learning architecture.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way

FIG. 1 is functional diagram of a connected vehicle, according to an exemplary embodiment;

FIG. 2 is a functional diagram of a system for interactive learning, according to an exemplary embodiment;

FIGS. 3A-3C are functional diagrams of control modules for the system of FIG. 2, according to an exemplary embodiment; and

FIG. 4 is a functional flow block diagram of a method of using the system of FIG. 2 for interactive learning, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

As used herein, the terms module, component module, control module, or controller refer to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

The connecting lines shown in the various figures contained herein are intended to represent example functional relationships and/or physical couplings between the various elements. Conventional techniques may be used for signal processing, data transmission, signaling, control, and other functional aspects of the systems (and the individual operating components of the systems) may not be described in detail herein. It should be noted that many alternative or additional functional relationships or physical connections may be present in an embodiment of the present disclosure.

The following disclosure proved an efficient system and method that enables comprehensive learning based on data campaigns that are managed by using cloud computing services in communications with one or more connected vehicles. A data campaign is a strategy and/or action to gather information or data to satisfy a particular need or want for a connected vehicle. A non-limiting example of a data campaign is to collect operation data on a vehicle system and feed the collected data into a machine learning architecture to update or develop a new software application for the vehicle system.

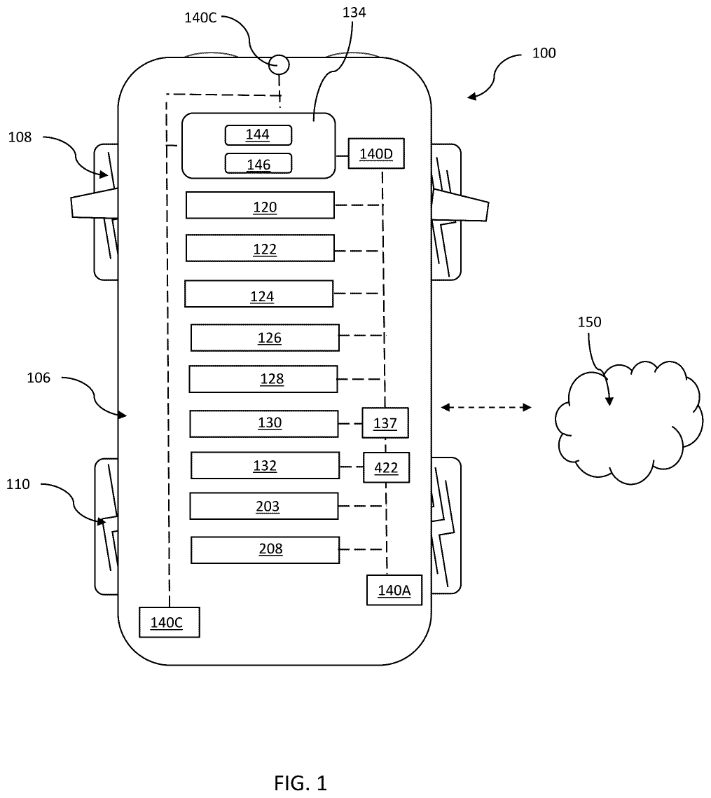

FIG. 1 is a functional diagram of a connected vehicle 100 configured for wireless communications including, but not limited to, vehicle-to-vehicle (V2V) communications, vehicle-to-infrastructure (V2I) communications, and cellular-based-to-vehicle communications (C-V2X) technology, and connectable directly or through such wireless communications to cloud computing services 150, also referred to as the cloud 150.

The vehicle 100 generally includes a body 106, front wheels 108, and rear wheels 110. The body 106 substantially encloses the systems and components of the vehicle 100. The front wheels 108 and the rear wheels 110 are each rotationally coupled to the body 106 near a respective corner of the body 106. Although the connected vehicle 100 is shown as a sedan, it is envisioned that that connected vehicle 100 may be another type of on-road vehicle, such as a pickup truck, a coupe, a sport utility vehicle (SUVs), a recreational vehicle (RVs), and a motorcycle. Irrespective of the type of vehicle, the connected vehicle 100 may be a smart vehicle equipped with an Advanced Driver-Assistance System (ADAS) configured to enhance the safe operation of the vehicle and/or equipped with an Automated Driving System (ADS) capable of operating from Level 0 (no driving automation) to Level 5 (full driving automation) in accordance with SAE J3016 levels of driving automation.

As shown, the vehicle 100 generally includes a propulsion system 120, a transmission system 122, a steering system 124, a brake system 126, a detection system 128, and a vehicle communications system 130. The vehicle 100 further includes a smart buffer 203 and a vehicle data hub control module 208, both of which are described in detail below. The detection system 128 is in communications with a plurality of vehicle sensors including navigation sensors 140A, vehicle state sensors 140B, external sensors 140C, and internal sensors 140D.

The plurality of sensors 140A-140D collect information and generate sensor data indicative of the collected information. As non-limiting examples, the navigation sensors 140A may include Global Navigation Satellite System (GNSS) transceivers or receivers; the vehicle state sensors 140B may include yaw rate sensors, and speed sensors; external sensors 140C may include cameras, lidars, radars, and ultrasonic sensors; and internal sensors 140D may include in-cabin cameras and cabin interior temperature sensors. The GNSS transceivers or receivers are configured to detect the location of the connected vehicle 100. The speed sensors are configured to detect the speed of the connected vehicle 100. The yaw rate sensors are configured to determine the heading of the connected vehicle 100. The external cameras may have a field of view large enough to capture images in front, in the rear, and in the sides of the connected vehicle 100. The internal sensors may detect the current attention state of a vehicle operator.

The vehicle communication system 130 may include one or more communication transceiver 137 in connection with a network access manager 422. Each of the communication transceiver 137 is configured to wirelessly communicate information, or data, to and from other remote entities, such as other connected vehicles, RSU, and MEC, (through “V2V” communication), infrastructure (through “V2I” communication), remote systems at a back office, and/or cloud computing service providers 150. The communication transceiver 137 may be configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

A vehicle controller 134 is in communication with the vehicle systems, sensors, smart buffer 203, and vehicle data hub control module 208 using a Controller Area Network (CAN) 132 and/or ethernet. The vehicle controller 134 is configured to collect data on the vehicle system and sensor data collected by the plurality of sensors 140A-140D. The vehicle controller 134 includes at least one vehicle processor 144 and a vehicle non-transitory computer readable storage device or media 146. The vehicle processor 144 may be a custom made or commercially available processor, a central processing unit (CPU), a graphics processing unit (GPU), an auxiliary processor among several processors associated with the vehicle controller 134, a semiconductor-based microprocessor (in the form of a microchip or chip set), a macro processor, a combination thereof, or generally a device for executing instructions. The vehicle computer readable storage device or media 146 may include volatile and nonvolatile storage in read-only memory (ROM), random-access memory (RAM), and keep-alive memory (KAM), for example. KAM is a persistent or non-volatile memory that may be used to store various operating variables while the vehicle processor 144 is powered down. The vehicle computer-readable storage device or media 146 of the vehicle controller 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 134 in controlling the connected vehicle 100.

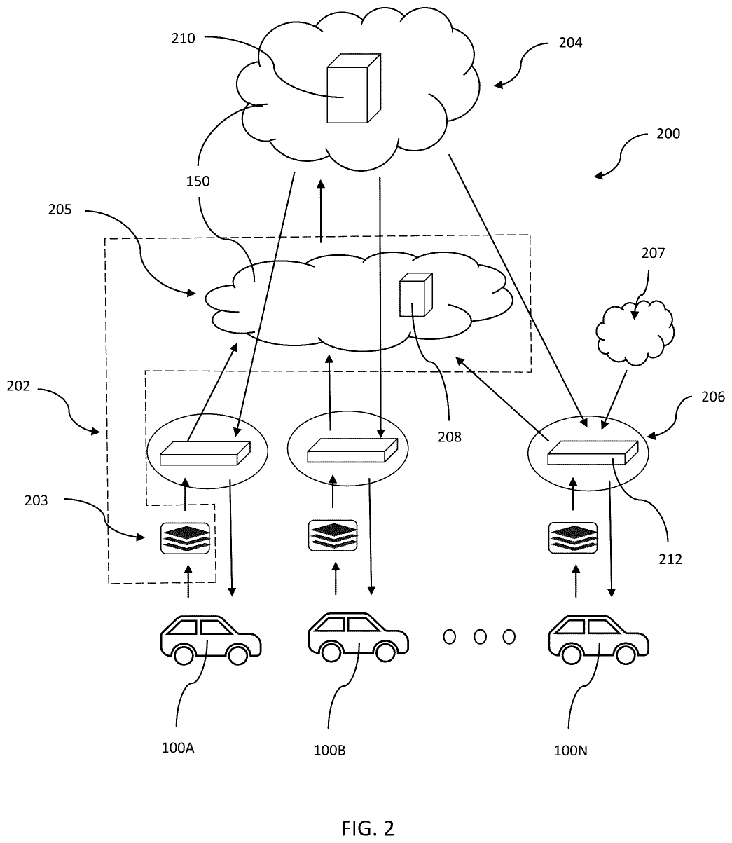

FIG. 2 shows a system 200 for enabling interactive learning framework for connected vehicles 100A-100N. The system 200 includes a Vehicle Data Hub (VDH) component 202, a System Learning and Update (SLU) component 204, and an Application Delivery Network (ADN) component 206. The ADN component 206 resides on the vehicle and includes a policy engine 207 in the cloud that is capable of configuring certain operational details of the ADN component 206. The system 200 enables a comprehensive learning method based on cloud computing services for data campaign management and the connected vehicle 100 capabilities of onboard data collection, buffering, and data pipe selection. The cloud computing services 150, also referred to as the cloud 150, includes a network of cloud servers and data depositories that are hosted on the internet to store, manage, and process the data collected by the one or more connected vehicles 100. The cloud 150 delivers on-demand computing resources over a network, such as the internet. On-demand means the user can unilaterally provision computing capabilities, such as cloud server time and network storage, as needed without requiring human interaction with the service provider. Cloud servers often have functions distributed over multiple locations and functions similar to physical servers.

The VDH component 202 may include hardware and software residing both on the connected vehicle 100 and on the cloud 150. The VDH component 202 is configured to facilitate data collection requests and intelligent buffering of such requests by utilizing a smart buffer 203 disposed onboard the vehicle 100. The SLU component 204 is a cloud based service configured to manage multiple data campaigns and deployment by enabling flexible data campaign definitions and methods to operationalize the data campaign. The ADN component 206 is disposed onboard the connected vehicle 100 and includes a policy engine 207 in the cloud that is capable of configuring certain operational details of the ADN component 206. The ADN component 206 is configured to prioritize data campaign requests with respect to other active vehicle services that requires the transmission of data such as navigation, streaming services, communication, autonomous control of the vehicle 100, etc. The ADN component may cooperate with the vehicle communications system 130 to securely and efficiently provisions vehicle network access management services to fulfill data campaign requirements by dynamically selecting network medium such as cellular or Wi-Fi service based on criteria such as urgency, cost, etc.

The ADN component 206 coordinates with the vehicle communications system 130 to wirelessly upload collected data to the VDH cloud based portion 205 and wirelessly download data campaign instructions and software applications from the SLU component 204 in a data efficient and cost effective manner. The VDH cloud based portion 205 and the SLU component 204 may be configured for wired or wireless communications with each other. Wired communications may be effectuated by transmission of data over a wire-based communication technology including, but not limited to, telephone networks, internet access, ethernet cables, and fiber-optic communications. Wireless communications include, but not limited to, vehicle-to-vehicle (V2V) communications, vehicle-to-infrastructure (V2I) communications, vehicle-to-anything (V2X), radio communication, and cellular-based communications networks.

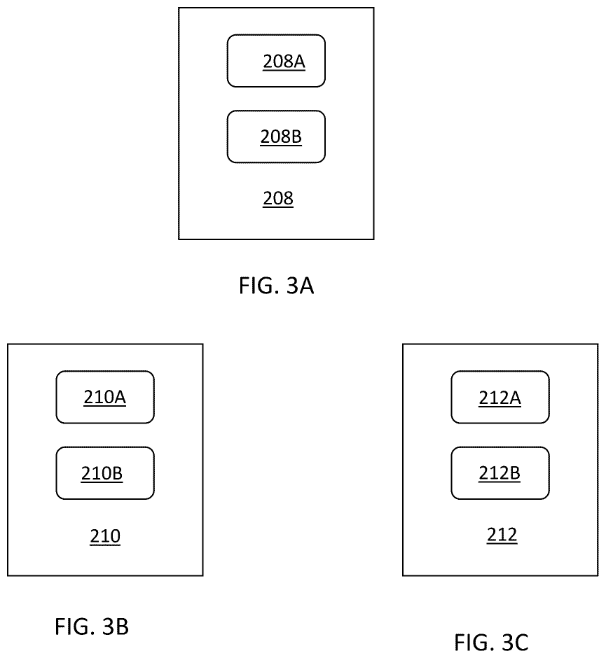

Referring to FIG. 3, each of the VDH component 202, SLU component 204, and ADN component 206 includes one or more respective control modules 208, 210, 212 The VDH control module 208, SLU control module 210, and ADN control module 212 are configured to implement the functions of the respective VDH, SLU, and ADN components 202, 204, 206. The VDH control module 208 may be located on the connected vehicle or on the cloud, or both on the connected vehicle and the cloud. The SLU control module 210 may be located on the cloud or a server in a back office. The ADN control module 212 may be located onboard the connected vehicle and in communications with a policy engine 207 component located on the cloud that is capable of configuring the behavior of the ADN component 206 onboard the vehicle.

Each of the VDH, SLU, and ADN control modules 208, 210, 212 includes a respective system processor 208A, 210A, 212A and a respective system non-transitory computer readable storage device or media 208B, 210B, 212B. The system processor 208A, 210A, 212A may be a custom made or commercially available processor, a central processing unit (CPU), a graphics processing unit (GPU), an auxiliary processor among several processors associated with the control module, a semiconductor-based microprocessor (in the form of a microchip or chip set), a macro processor, a combination thereof, or generally a device for executing instructions. The system computer readable storage device or media 208B, 210B, 212B may include volatile and nonvolatile storage in read-only memory (ROM), random-access memory (RAM), and keep-alive memory (KAM), for example. KAM is a persistent or non-volatile memory that may be used to store various operating variables while the system processor is powered down. The system computer-readable storage device or media of the control module may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions. The system non-transitory computer readable storage device or media may store instructions for the execution of the Method 400 below. The instructions may include one or more separate programs, each of which comprises an ordered listing of executable instructions for implementing logical functions.

Although a single control module is shown for each of the VDH, SLU, and ADN components 202, 204, 206, it should be appreciated that each of the VDH, SLU, and ADN components 202, 204, 206 may include a plurality of respective control modules 208, 210, 212 that communicate over a suitable communication medium or a combination of communication mediums and cooperate to process the sensor signals, perform logic, calculations, methods, and/or algorithms, and generate control signals to execute the functions of the VDH, SLU, and ADN components 202, 204, 206.

The VDH component 202 provides performance monitoring and logging; secure storage, data schema for representation and parsing, system state management; and cloud data adaptation. The VDH control module 208 interfaces with the onboard vehicle bus architectures such as ethernet and controller area network (CAN); execute data campaign deployment instructions to monitor signals of interest; implements smart buffer process that intelligently stores collected data and attaches priority, expiration, and other attributes to the collected data to preserve or purge data depending on the needs of the data campaign. The VDH control module 208 is further configured to engage cloud services that ingest and curate vehicle data for publishing of topics and long-term retention.

The SLU component 204 manages data campaigns based on predetermined trigger events to save on computing resources including data bytes collected, stored, and transmitted. The SLU module 210 may be configured to collect and process data based on rules that are determined based on the requirements of the data campaign. The collected data may be inputted into a machine learning architecture utilized for updating vehicle software applications or for development of new software applications. The updated or new software applications are transmitted to the ADN component.

The SLU Module 210 may be configured to begin collecting data only upon a detection of a predetermined trigger event or a combination of predetermined trigger events. In a non-limiting example, the collection of data gathering is initiated only when an active safety feature escalates AND the driver takes an affirmative action such as depressing the brake pedal. In another non-limiting example, the triggering event may be that of a connected vehicle entering or within a predetermined geospatial area. When the predetermined triggering or combination of trigger events is detected, a 3-second sample of data can fully reconstruct the scenario including location, surrounding actors, and driver behavior associated with the triggering events. The predetermined trigger events may be dynamically added, removed, and redefined during the campaign to enable sufficient, but not excessive, data collection. For example, if the request is for 100 scenarios of a certain type (i.e., collect 100 set of data based on a certain event), then the data collection system will enroll selected vehicles, collect data until it reaches a total of 100 scenarios, and then close the campaign.

The ADN component 206 ensures quality of experience for vehicular application data delivery via data pipe selection and data management techniques, and provides dynamic quality of service control for automotive ethernet. The ADN module 206 is configured to facilitate secure and efficient software application delivery to the connected vehicle; performs integration between the vehicle communications system and network access management service to fulfill data collection goals by offboarding requested data using cellular, Wi-Fi, V2V, V2I, V2X, and other wireless communications based on cost economics.

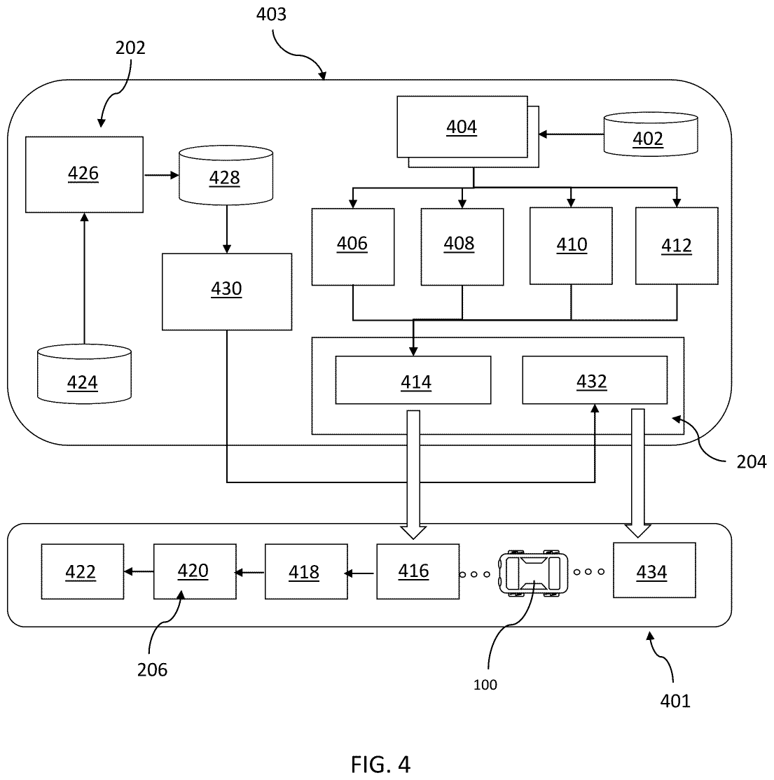

FIG. 4 shows a functional flow diagram of a Method 400 of interactive learning for connected vehicles using the system 200. The Method 400 includes data collection operations by a fleet 401 of connected vehicles 100 and data processing operations on the cloud 403. The Method 400 begins in the cloud 403 at Block 402 by querying an application tracking database 402 to determine if there is a need or want to develop a new software application and/or update an existing software application for the fleet 401 of connected vehicles 100. The software application is also referred to as an APP. The APP may be used to control a physical operation of the vehicle 100 such as activating a vehicle safety system or taking partial to full autonomous control of the vehicle 100 or a system of the vehicle 100. The method proceeds to Block 404 in response to a determined need or want to develop or update the APP.

Proceeding to Block 404, the data requirements for developing or updating of the APP are identified. The data requirements include, but are not limited to, a data aspect 406, a spatial aspect 408, a temporal aspect 410, and a policy aspect 412. The data aspect 406 is the type of data (also referred to as data type) required for the development or update of the APP. The types of data may include, but are not limited to, vehicle systems data such as ADAS activation data and ADS performance data, occupant data such as driver attentiveness and response data, and external operating condition data such as weather and road conditions. The spatial aspect 408 may include, but not limited to, map regions or areas where the collection of data is limited within. The regions or areas may be defined by a geofence, by road classification or segment, a designated zone such as a work zone, and area classifications such as sensitive military areas. The temporal aspect 410 may include, but not limited to, the time period (start and end dates) allocated for the collection of data, sampling rate for the collecting of the data, and buffer configuration based on the importance of the data and buffer space availability. The policy aspect 412 may increase the collection of a predetermined data type based on subscription to a third-party service and regulatory programs such as emissions, or decrease or halt the collection of data based on sensitivity of location such as near a military facility or school.

Proceeding to Block 414, based on the identified data requirements for the APP, including the data aspect 406, spatial aspect 408, temporal aspect 410, and policy aspect 412, the SLU component 204 generates a data campaign request including instructions for collecting the identified data requirements. The SLU component 204 enable flexible data campaign definitions and methods to operationalize the data campaign by allowing real-time updates in the instructions such as adding and removing trigger events. The SLU component 204 may manage multiple data campaigns by consolidating the data collection efforts, prioritizing the collection of data types, and defining triggering events before the collection of data types.

The SLU control module 210 may define geographic and/or situational trigger events before the act of data collection is initiated by a connected vehicle. In a non-limiting example, a participating connected vehicle 100 would only initiate data collection when the participating vehicle enters into or is within a geofence area based on a bounding box, geohash, or GPS decimal precision. The situational requirement may require the collection of data based on conditional evaluation of vehicle signals using mathematical operators. Such conditional evaluations may depend on a trigger event such as alerts, engagement/disengagement of a safety system, proximity to detect features and quality; driver behaviors such as driver initiated acceleration, deceleration, steering, and other driver inputs; environmental conditions such as day, night, rain, fog etc. The data requirements may be general or selective. General data requirements may require light sampling across large numbers of connected vehicles. Selective requirements may require heavy sampling across a small number of connected vehicles.

Proceeding to the fleet component 401, at Block 416, the VDH control module 208 receives instructions for the data campaign from the SLU component 204. The VDH control module 208 coordinates data collection from at least one of the plurality of vehicles 100A-100N using smart buffer intelligent data caching and retrieval method implemented by the smart buffer 203 onboard the connected vehicle 100. At Block 418 the collected data is processed by the smart buffer 203 to select and prioritize data based on campaign rules.

Proceeding to Block 420, the ADN component securely and efficiently delivers the collected data to the cloud component 403 via the network access manager 422 to a central depository 424, also referred to as a data lake 424. The ADN component 206 dynamically selects wireless network services based on criteria such as urgency, cost, etc., to upload the collected data to the data lake 424. The data lake 424 receives the data and may store the data as-is without structuring the collected data.

Proceeding to Block 426, the VDH component 202 on the cloud 150 retrieves the data from the data lake 424, provisions, and curates the data in accordance with the data campaign instructions. The structured data is stored in a data depository 428 that includes one or more databases that manage and store the structured data for data analytical processes.

At Block 430, the data is retrieved from the data depository and processed in accordance with the campaign rules. In non-limiting examples, the collected data may be processed by trip catalogs, data imputation, data categorization, data clustering, anomaly detection, and trend analysis. Proceeding to Block 432, the SLU component 204 process the data in accordance with the campaign rules to for calibration updates, algorithm updates, software core updates, and/or software build and development. In a non-limiting example, the collected data may be fed into a machine learning architecture utilized for updating vehicle software applications or for development of new software applications for a physical operation of the vehicle 100.

At Block 434, the ADN module 212 securely and efficiently provisions vehicle network access management services to fulfill data campaign requirements by dynamically selecting over the air (OTA) network medium such as cellular or Wi-Fi service based on criteria such as urgency, cost, etc. to download the updated and/or new APP to the fleet of connected vehicles 100. The connected vehicles 100 execute the updated/new software to physically operate one of more of the vehicle systems.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A system for enabling interactive learning for connected vehicles, comprising:
a system learning and update (SLU) component comprising a SLU module configured to:
generate data campaign requests including instructions to collect data by a connected vehicle,
send the instructions to the connected vehicle to collect the data,
receive collected data from the connected vehicle,
process the collected data to generate a software application (APP), and
send the APP to the connected vehicle;
a vehicle data hub (VDH) component comprising a VDH module configured to:
assign a priority to the collected data,
send the collected data to the SLU module based on the assigned priority from the connected vehicle, and
select a wireless communications network to send the collected data based on cost economics; and
an application delivery network (ADN) component comprising an ADN module configured to prioritize the data campaign requests with respect to other active vehicle services.

2. The system of claim 1, wherein:
the instructions include a data requirement; and
the VDH component comprises a smart buffer disposed on the connected vehicle, wherein the smart buffer is configured to prioritize the collected data based on the data requirement and a need of the connected vehicle.

3. The system of claim 2, wherein the instructions includes detecting a predetermined triggering event before the connected vehicle initiates collecting the data.

4. The system of claim 3, wherein the data requirement comprises at least one of a data aspect, a spatial aspect, a temporal aspect, and a policy aspect.

5. The system of claim 1, wherein the SLU module is further configured to generate updated instructions and send the updated instructions to the connected vehicle in real-time.

6. The system of claim 1, wherein the SLU module is further configured to process the collected data to generate an updated software application (APP) by feeding the collected data to a machine learning architecture.

7. The system of claim 1, wherein the SLU component is implemented on-demand by a cloud computing service.

8. The system of claim 1, wherein the VDH component comprises a cloud-based VDH portion configured to monitor the collected data including at least one of monitoring, logging, secure storing, and parsing of the collected data.

9. The system of 1, wherein the ADN module is configured to interact with a vehicle communications system and a network management system disposed on the connected vehicle for sending the collected data and receiving the APP.

10. The system of claim 3, wherein the triggering event is the connected vehicle entering a predetermined geospatial area.

11. A method of enabling interactive learning for connected vehicles, comprising:
generating instructions, by a system learning and update (SLU) module, for a connected vehicle to collect data;
selecting a first wireless communications network, by an application delivery network (ADN) module, to transmit the instructions to a connected vehicle;
collecting data, by the connected vehicle, in accordance with the instructions;
assigning a priority, by a vehicle data hub (VDH) module, to the collected data before transmitting the collected data to the SLU module;
processing the collected data, by the SLU module, to generate a software application (APP) for a vehicle system on the connected vehicle;
selecting a second wireless communications network, by the ADN module, to transmit the APP to the connected vehicle; and
executing the APP, by a vehicle controller, to physically control the vehicle system.

12. The method of claim 11, wherein the instructions include detecting a trigger event before initiating the collecting of data.

13. The method of claim 12, wherein the trigger event includes at least two event selected from the group consisting of an activation of a predetermined feature of the vehicle, a predetermined observation by the vehicle, and a predetermined action by an operator of the vehicle.

14. The method of claim 12, wherein the predetermined feature of the vehicle includes an autonomous emergency braking, a detected object, and, and an action of an operator of the vehicle.

15. The method of claim 11, wherein the instructions includes a data requirement comprising at least one of a data aspect, a spatial aspect, a temporal aspect, and a policy aspect.

16. A system for enabling interactive learning framework for connected vehicles, comprising:
a Vehicle Data Hub (VDH) component comprising a smart buffer disposed onboard a connected vehicle and a VDH service portion on a cloud;
a System Learning and Update (SLU) component disposed on the cloud; and
an Application Delivery Network (ADN) component disposed onboard the connected vehicle;
wherein the SLU component is configured to generate a data campaign request and communicate the data campaign request to the connected vehicle, wherein the data campaign includes instructions for collecting data by the connected vehicle;
wherein the VDH component is configured to assign a priority to data collected by the connected vehicle; and
wherein the ADN component is configured to prioritize multiple data campaign requests with respect to other active vehicle services.

17. The system of claim 16, wherein the VDH component is further configured to select a wireless communications network for sending the collected data to the SLU component based on cost economics.

18. The system of claim 16, wherein the VDH component includes a smart buffer configured to prioritize the collected data based on data requirement and a need of the connected vehicle.

19. The system of claim 16, wherein the SLU component is further configured to generate updated instructions for collecting data by the connected vehicle and send the updated instructions to the connected vehicle in real-time.

20. The system of claim 19, the SLU component is further configured to process the collected data to generate an updated software application (APP) by feeding the collected data to a machine learning architecture.
